(19) United States
(12) Patent Application Publication
(10) Pub. No.: US 2011/0246152 A1
(43) Pub. Date: Oct. 6, 2011

(54) Apparatus and Method for Improving the Simulation of Object Streams in the Case of Opposed Object Streams and, in Particular, to Drive Control Centers

(76) Inventors: Wolfram KLEIN, Neubiberg (DE); Gerta KÖSTER, Munchen (DE); Andreas MEISTER, Mering (DE)

(21) Appl. No.: 13/163,185

(22) Filed: Jun. 17, 2011

Related U.S. Application Data
(63) Continuation of application No. PCT/EP2009/067254, filed on Dec. 16, 2009.

(30) Foreign Application Priority Data
Dec. 17, 2008 (DE) 10 2008 063 455.7

(51) Int. Cl. G06F 17/16

(52) U.S. Cl. 703/2

(57) ABSTRACT

A method and apparatus for the simulation of object streams moving in an area based on cellular state machines can be improved such that the simulation maps the object streams as realistically as possible. It is also being proposed that the norm of a difference vector having direction of movement of an object and the direction of movement of a neighboring object is also incorporated as a weighting factor in a calculation of the object potential. Thus, conventional methods for the simulation of object streams are improved. The method and apparatus is particularly suitable for streams of people.

### CROSS-REFERENCE TO RELATED APPLICATIONS

This application is a Continuation of International Application No. PCT/EP2009/067254 filed Dec. 16, 2009, which designates the United States of America, and claims priority to German Application No. 10 2008 063 455.7 filed Dec. 17, 2008, the contents of which are hereby incorporated by reference in their entirety.

### TECHNICAL FIELD

The present invention relates to an apparatus and to methods for improving the simulation of object streams in the case of opposed object streams.

### BACKGROUND

Wherever people or objects appear in large numbers phenomena occur that are typical of masses. Some of these phenomena are a threat to the safety of life and limb, for instance if panic breaks out during a large scale event. Further phenomena require suitable steering mechanisms in order to efficiently shape procedures from technical and financial perspectives. Examples of this are an “evacuation” of an area following a large scale event, by way of example of a football stadium and its surroundings, or the guidance of road traffic during rush hour.

According to the prior art some approaches already exist for simulating flows of people and automobiles in particular. However, the conventional approaches have shortcomings which limit accurate mapping of mass phenomena and therefore the usability of simulation results.

Solutions are being sought, which remedy some conventional shortcomings in a method described here, to thus obtain productive modeling and simulation of streams of people/objects which forms a module of a command and control center, i.e. a control unit for object streams and in particular streams of people.

When planning large buildings or means of mass transportation streams of people simulators are conventionally used to recognize bottlenecks and points of conflict, for example in corridors or stairwells, in as early a planning phase as possible and to provide the infrastructure with sufficient dimensions. A primary aim of conventional streams of people simulators is the calculation of evacuation times in the case of unusual events, by way of example in the case of fire, in order to be able to produce the evidence of evacuation times demanded by legislators.

One approach to a stream of people simulation that is often chosen involves apparatus and methods based on “cellular state machines” [1]. In this case an area, by way of example a street, is overlaid with a cellular grid. A hexagonal grid has been chosen by way of example in FIG. 1. Square cells are also common. Each cell can adopt different occupation states, for instance filled and, more precisely, with an obstruction, or occupied by a person, or empty. Such states are updated by way of rule sets or machines over time. The following sub-models and their interaction contain the key ideas of these machines:
a target model establishes how objects/people move toward a target.
a model relating to the movement of objects or people establishes how objects/people behave among each other.
an obstruction model defines how objects/people move around obstructions.

One approach is accordingly proven in this case and mimics the known mechanism from the physics of electronics. This is achieved in the mathematical formulation by way of potential fields.

Targets attract objects/people in the same way that a positive charge attracts electrons. The strength of the potential field is determined in the prior art [1] as the function of the Euclidean distance of the person/object from the target. One example is given in this regard for the purpose of better understanding:

The potential field of a punctiform target results from the coordinates of the target z of the person currently being considered x^{AP}, scaled by a factor S. ∥.∥ denotes the Euclidean norm. In accordance with a cone in a two-dimensional space the scaling factor S determines the width of the opening of the target potential. Formula 1 shows an example of a potential function for a punctiform target with a weighting factor S:

U(x^{AP})=S·∥z−x^{AP}∥ Formula (1)

Objects/people mutually repel each other like electrons repel one another. The strength of the potential field is conventionally determined as a function of the Euclidean distance of the people/objects from each other.

Obstructions repel objects/people like a negative charge repels electrons. The strength of the potential field is conventionally determined as a function of the Euclidean distance of the person/object from the obstruction.

A method with cellular state machines has the following advantages. Simulation results can be obtained very quickly on a computer even for very large numbers of people or objects. This requires a slimline implementation. The results with cellular state machines are closer to reality than, for instance, with macroscopic simulations. The model of the cellular state machines is very flexible in order to map a large number of different scenarios. The depiction of the filled or empty cells simultaneously provides an intuitively comprehensible visualization. Simulators which are based on cellular state machines may, moreover, be easily expanded to form interactive simulators.

Drawbacks of the method are evident with cellular state machines according to the prior art. The, in principle, very powerful approach by way of potential fields according to the current prior art has some drawbacks which severely limit the practical exploitation of simulation results. This applies in particular to the correct mapping of observed and measured mass and movement phenomena without which practical use of a simulator is restricted. The following drawback results:

One drawback of the conventional method lies in an incorrect reproduction of the image of pathways in the case of opposed streams of people. Typical pathways form if volumes of people are flowing against each other, by way of example on a street or at crossroads. This pathway formation cannot be reproduced using a conventional simulator, as FIG. 2 shows at the top. Although people are initially sent opposite each other so as to be divided in pathways, even from staggered sources, an unordered throng develops in the center with the method according to prior art.

### SUMMARY

According to an embodiment, in an apparatus for generating movements of objects detected by means of a first detection device on a spatial area of the apparatus, wherein the area is overlaid with a cellular grid and each cell can adopt different occupation and total potential states which are adjusted by means of a calculating device and a control device and are updated over time, a target potential is allocated to each cell which determines how objects are attracted by a target, and an obstruction potential is allocated, which determines how objects are repelled by an obstruction, and wherein a object potential is allocated to each object, wherein a total potential in a cell is composed of the values of the target potential and the obstruction potential in the cell and the object potentials of objects, detected by means of the first detection device, in neighboring cells of the cell, and, starting from a respective starting cell, objects each switch from one cell to a neighboring cell with the lowest total potential, characterized in that a norm of a difference vector comprising direction of movement of a object, detected by means of the first detection device, and a direction of movement of a neighboring object is also incorporated as a weighting factor in a calculation of the respective object potential performed by means of the calculating device.

According to a further embodiment, the respective new object potential can be calculated by means of the calculating device according to the following formula:

Pot_{new}(O)=c(α)*Pot(O)

where c(α) is the norm of the difference vector.

According to a further embodiment, the norm of the difference vector can be calculated by means of the calculating device according to the following formula:

c(α)=∥\vec{v}_{currentpers(α)}−\vec{v}_{neighbor(α)}∥*a+b, with a and b weighting factors

where \vec{v}(α) is the normalized direction vector of a object.

According to a further embodiment, the normalized direction vector of a object can be calculated by means of the calculating device according to the following formula:

$$\vec{v} ( α ) = ( \begin{matrix}sin α \\ cos α\end{matrix} )$$

where α indicates the angle, detected by means of the first detection device, of the direction of movement with respect to the target of the object.

According to a further embodiment, the object potential Pot(O) can be determined by means of the calculating device by a function of the Euclidean distances of the objects from each other detected by means of the first detection device. According to a further embodiment, target potential and obstruction potential can each be determined by a function of the Euclidean distances of a object, detected by means of the first detection device, from the target and of a object from an obstruction. According to a further embodiment, the function of the Euclidean distances can be a linear, quadratic or an exponential function. According to a further embodiment, real object movements can be detected by means of a second detection device for the initialization of positions of the objects, of starting cells, targets and object speeds. According to a further embodiment, the apparatus can comprise an evaluation device for evaluating the object movements detected by means of the first detection device. According to a further embodiment, the evaluation device may generate control pulses to a control center. According to a further embodiment, the apparatus can comprise the control center for controlling building elements. According to a further embodiment, building elements can be doors, windows, signs, loudspeakers, elevators, escalators and/or lights.

According to another embodiment, a method for generating object streams, may comprise the following steps: —providing an apparatus having a spatial area overlaid with a cellular grid, wherein each cell adopts different occupation and total potential states which are adjusted by means of a control device and a calculating device, wherein a target potential is allocated to each cell which determines how objects are attracted by a target, and an obstruction potential is allocated which determines how objects are repelled by an obstruction, and wherein a object potential is allocated to each object, wherein a total potential in a cell is composed of the values of the target potential and the obstruction potential in the cell and the object potentials of objects, detected by means of a first detection device, in neighboring cells of the cell; —positioning objects on respective starting cells, wherein thereafter the objects each switch from one cell to a neighboring cell with the lowest total potential, —detecting the positions of the objects by means of the first detection device, —updating the total potential states by means of the first detection device, the calculating device and the control device,

characterized in that a norm of a difference vector comprising direction of movement of a object, detected by means of the first detection device, and a direction of movement of a neighboring object is also incorporated as a weighting factor in a calculation of the respective object potential performed by means of the calculating device.

According to a further embodiment of the method, the respective new object potential can be calculated by means of the calculating device according to the following formula:

Pot_{new}(O)=c(α)*Pot(O)

where c(α) is the norm of the difference vector.

According to a further embodiment of the method, the norm of the difference vector can be calculated by means of the calculating device according to the following formula:

c(α)=∥\vec{v}currentpers(α)−\vec{v}_{neighbor(α)}∥*a+b, with a and b weighting factors

where \vec{v}(α) is the normalized direction vector of a object.

According to a further embodiment of the method, the normalized direction vector of a object can be calculated by means of the calculating device according to the following formula:

$$\vec{v} ( α ) = ( \begin{matrix}sin α \\ cos α\end{matrix} ) ,$$

where α indicates the angle, detected by means of the first detection device, of the direction of movement with respect to the target of the object.

According to a further embodiment of the method, object potential Pot(O) can be determined by means of the calculating device by a function of the Euclidean distances of the objects from each other detected by means of the first detection device. According to a further embodiment of the method, target potential and obstruction potential are each determined by a function of the Euclidean distances of a object, detected by means of the first detection device, from the target and of a object from an obstruction. According to a further embodiment of the method, the function of the Euclidean distances is a linear, quadratic or an exponential function. According to a further embodiment of the method, the method may comprise detecting real object movements by means of a second detection device for the initialization of positions of the objects, of starting cells, targets and object speeds. According to a further embodiment of the method, an evaluation device may evaluate the object movements detected by means of the first detection device. According to a further embodiment of the method, the evaluation device may generate control impulses to a control center. According to a further embodiment of the method, the control center may control building elements. According to a further embodiment of the method, building elements can be doors, windows, signs, loudspeakers, elevators, escalators and/or lights.

According to yet another embodiment, an apparatus as as described above can be used for the simulation and/or control of object streams, streams of people or animal movements.

According to a further embodiment, the method as described above can be used for the simulation and/or control of object streams, streams of people or animal movements.

According to yet another embodiment, a method for the simulation of object streams moving in an area based on cellular state machines, wherein the area is overlaid with a cellular grid and each cell can adopt different states which are updated by way of rule sets over time, may comprise:
basing the rule sets on sub-models which determine how objects are attracted by a target, how objects mutually repel each other and how objects are repelled by an obstruction, and
basing the rule sets on a mathematical formulation of a total potential field over the cellular grid, wherein the total potential in a cell is the sum of values of target potential, object potential and obstruction potential in the cell and objects switch from one cell to a neighboring cell with the lowest total potential, wherein a norm of a difference vector comprising direction of movement of an object and a direction of movement of a neighboring object is also incorporated as a weighting factor in the calculation of the respective object potential.

According to a further embodiment of the above method, the respective object potential can be calculated according to the following formula:

Pot(O)=c(α)*Pot_{conv}(O)

where c(α) is the norm of the difference vector and Pot_{conv}(O) is a conventionally calculated respective object potential.

According to a further embodiment of the above method, the norm of the difference vector can be calculated according to the following formula:

c(α)=∥\vec{v}_{currentpers(α)}−\vec{v}_{neighbor(α)}∥*a+b, with a and b weighting factors

where \vec{v}(α) is the normalized direction vector of an object.

According to a further embodiment of the above method, the normalized direction vector of an object can be calculated according to the following formula:

$$\vec{v} ( α ) = ( \begin{matrix}sin α \\ cos α\end{matrix} )$$

where α indicates the angle of the direction of movement with respect to the target of the object. According to a further embodiment of the above method, the conventional object potential Pot_{conv}(O) can be determined by a function of the Euclidean distances of the objects from each other. According to a further embodiment of the above method, target potential and obstruction potential can be each determined by a function of the Euclidean distances of an object from the target and of an object from an obstruction. According to a further embodiment of the above method, the function of the Euclidean distances can be a linear, quadratic or an exponential function.

### BRIEF DESCRIPTION OF THE DRAWINGS

The present invention will be described in more detail with reference to exemplary embodiments in conjunction with the figures, in which:

FIG. 1 shows illustrations on the formation of a grid,

FIG. 2 shows an exemplary embodiment of a conventional simulation (top),

FIG. 2 shows an exemplary embodiment of a simulation (bottom),

FIG. 3 shows illustrations for linear and exponential potential field functions,

FIG. 4 shows an exemplary embodiment of an apparatus,

FIG. 5 shows an exemplary embodiment of an method.

### DETAILED DESCRIPTION

According to various embodiments, an improved method and apparatus and a device for simulating of object streams moving on an area based on cellular state machines can be provided such that the simulation maps the object streams as realistically as possible. In particular a correct reproduction of the formation of pathways in the case of opposed streams of people shall be given. Building on the prior art an apparatus and an additional method shall be provided which remedy the conventional shortcoming stated above. Much improved overall behavior of object streams should result, i.e. a correct mapping of actual behavior. Control pulses to a control center for controlling building elements can be generated by means of the apparatuses and methods according to various embodiments.

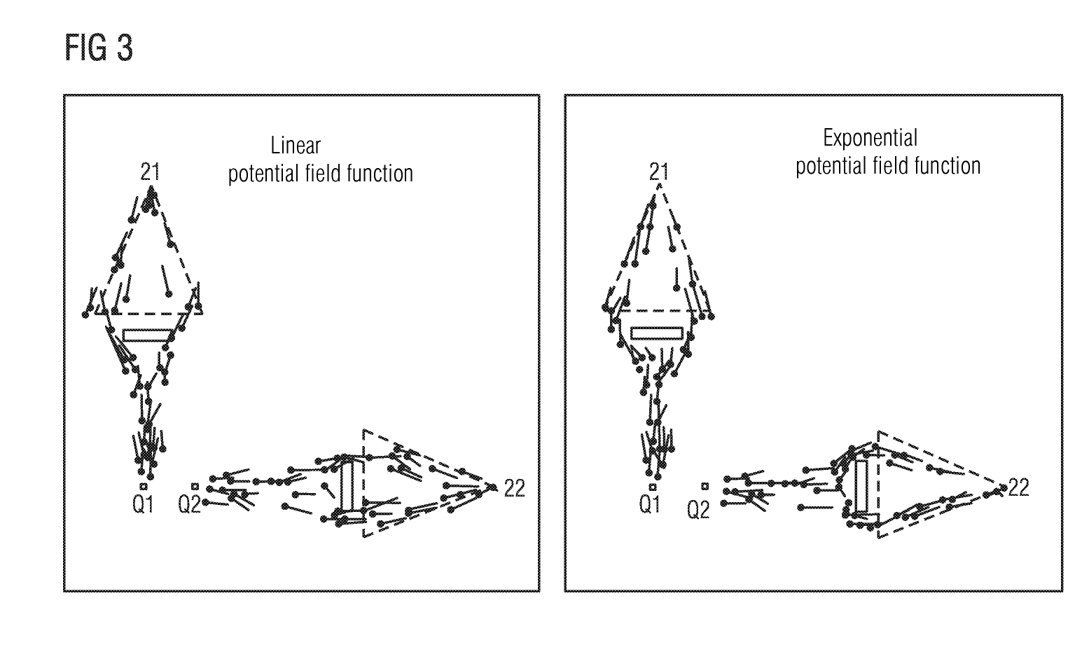

The functions of potentials described in the application can also be called potential field functions. By way of example, FIG. 3 shows a linear potential field function on the left and an exponential potential field function on the right.

The various embodiments focus on an apparatus and a method for generating streams of objects/people. This apparatus and this method may however be generally used for object streams. The various embodiments relate to object streams of any moving objects. Such objects can, for example, be metal balls. These objects can also, for example, be people, people on transportation means such as bicycles or motor vehicles, or these objects may also be animals.

According to various embodiments, an apparatus or method for simulation of object streams moving in an area based on cellular state machines can be provided, wherein the area is overlaid with a cellular grid and each cell can adopt different states which, for example can be adjusted by means of a control device, and are updated by way of rule sets over time, wherein the rule sets are based on sub-models which determine how objects are attracted by a target, how objects mutually repel each other and how objects are repelled by an obstruction, and more precisely, by means of the mathematical formulation of a total potential field over the cellular grid, wherein the total potential in a cell is the sum of the values of target potential, object potential and obstruction potential in the cell and objects switch from one cell to a neighboring cell with the lowest potential.

According to various embodiments a norm of a difference vector comprising direction of movement of an object and a direction of movement of a neighboring object is also incorporated as a weighting factor in a calculation of the respective object potential.

A detection device can, for example, be an optical detection device, by way of example a camera.

Occupation states can be: occupied by objects, obstruction, target or source or free therefrom.

A conventional model of the object potential is thus combined with a consideration of the direction of movement of the neighbor. In addition to the existing conventional object or person potential model Potconv(O), which is the repelling effect of a object/person, the direction of movement of the neighbor relative to the direction of movement of the object or person currently being considered is taken into account. Oncoming objects should offer more resistance than objects with a similar direction of movement.

The various embodiments remedy the shortcomings described in the prior art. The simulation of object streams, in particular streams of people, is significantly more realistic due to the various embodiments and the real behavior of object masses or masses of people, can be mapped better.

According to other embodiments, the apparatus can, for example, also be simulated by a computer and the associated model. The apparatus is particularly suitable for a simulation of streams of people in buildings by way of example.

According to other embodiments, a method for generating movements of objects, detected by means of a first detection device, on a spatial area of the apparatus can be provided, wherein the area is overlaid with a cellular grid and each cell can adopt different occupation and total potential states which are adjusted by means of a control device and are updated over time, wherein a target potential is allocated to each cell which determines how objects are attracted by a target, and an obstruction potential is allocated which determines how objects are repelled by an obstruction, and wherein a object potential is allocated to each object, wherein a total potential in a cell is composed of the values of the target potential and the obstruction potential in the cell and the object potentials of objects, detected by means of the first detection device, in neighboring cells of the cell, and, starting from a respective starting cell, objects each switch from one cell to a neighboring cell with the lowest total potential, wherein a norm of a difference vector comprising direction of movement of a object detected by means of the first detection device and a direction of movement of a neighboring object is also incorporated as a weighting factor in a calculation of the respective object potential performed by means of a calculating device.

According to other embodiments, a use of an apparatus or a method for the simulations and/or control, by means of a control center, of object streams, streams of people or animal movements can be provided.

According to an embodiment an object potential can be calculated, for example, by means of the calculating device as follows:

Pot_{new}(O)=c(α)*Potconv(O). Formula (1)

This modification means that for neighbors with a similar direction of movement the potential is weighted less strongly than for neighbors with a contrary direction of movement to the current objects. These have a repelling effect.

According to a further embodiment the norm of the difference vector can be calculated, for example, by means of the calculating device according to the following formula:

c(α)=∥\vec{v}_{currentpers(α)}−\vec{v}_{neighbor(α)}∥*a+b, with a and b Formula (2)

weighting factors, where \vec{v}(α) can be the normalized direction vector of a object.

When calculating the object potential the norm of the difference vector is calculated from the object's own direction of movement and the direction of movement of surrounding neighbors respectively and is also incorporated as a factor in the potential calculation. Object can be people.

According to a further embodiment the normalized direction vector of a object can be calculated, for example, by the calculating device according to the following formula:

$$\vec{v} ( α ) = ( \begin{matrix}sin α \\ cos α\end{matrix} ) , \qquad Formula ( 3 )$$

where α indicates the angle, detected by the detection device, of the direction of movement with respect to the target.

According to a further embodiment the object potential Pot(O) can be determined by means of the calculating device by a function of the Euclidean distances, detected, for example, by means of the detection device, of the objects from each other.

According to a further embodiment the target potential and obstruction potential can each be determined by a function of the Euclidean distances, detected, for example, by means of the detection device, of a object from the target and of a object from an obstruction.

According to a further embodiment the function of the Euclidean distances can be a linear, quadratic or an exponential function.

According to a further embodiment real object movements can be detected, for example, by means of a second detection device for the initialization of positions of the objects, of starting cells, targets and object speeds. Starting from a real situation of object movements, predictions can therefore be made particularly advantageously according to various embodiments in the spatial area. A second detection device can be a camera which captures a spatial area and object movements.

According to a further embodiment an evaluation device for evaluating the object movements detected, for example, by means of the first detection device can be provided. The evaluation device can provide predictions.

According to a further embodiment the evaluation device can, for example, drive a control center by means of control pulses. This can be done according to a prediction.

According to a further embodiment the control center can be provided for controlling building elements.

According to a further embodiment building elements can be doors, windows, signs, loudspeakers, elevators, escalators and/or lights.

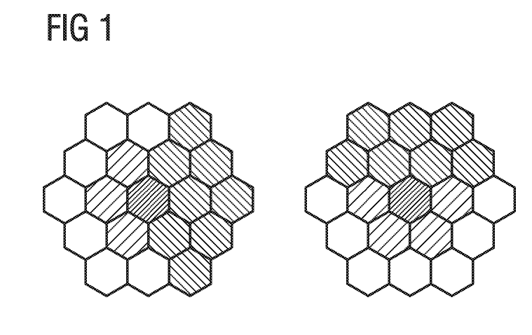

FIG. 1 shows an illustration on the formation of a grid. FIG. 1 shows the frequently chosen approach for generating stream of people simulations or object stream simulation on the basis of cellular state machines. Here an area, for example a street, is overlaid with a cellular grid. In FIG. 1 a hexagonal grid has been selected by way of example. Other cells are also common, for example square ones. Each cell can adopt different states, for instance filled, with an obstacle, occupied, by a object, or empty.

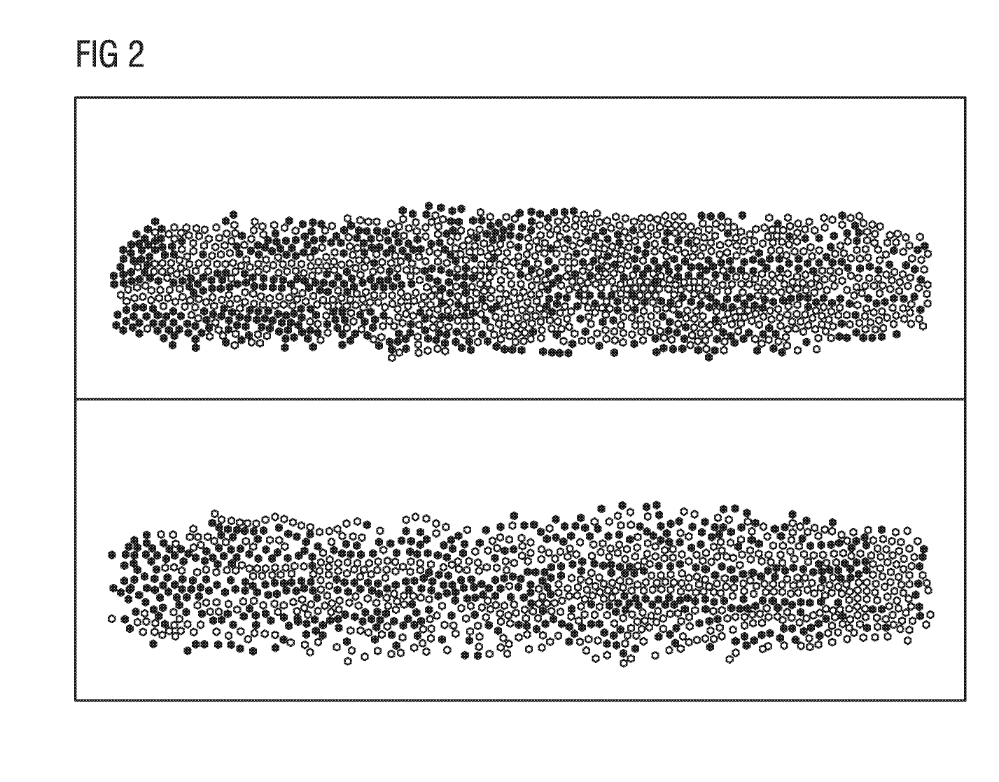

FIG. 2 (top) shows an exemplary embodiment of a conventional simulation. FIG. 2 (top) shows a conventional people model. According to this conventional model no pathways are formed. FIG. 2 (top) does not show the real, observed pathway formation in the case of a counter flow scenario in which one stream of people flows from left to right and one flows from right to left. According to the prior art in FIG. 2 (top) there is no correct reproduction of the formation of pathways in the case of opposed streams of people or object streams. If volumes of people flow against each other, for example on a road or at crossroads, typical pathways form. This pathway formation cannot be reproduced using the simulator according to the prior art, as FIG. 2 (top) shows. Although people are initially sent opposite each other so as to be divided in pathways, even from staggered sources, an unordered throng develops in the center with the method according to prior art.

FIG. 2 (bottom) shows an exemplary embodiment of a simulation according to the various embodiments. FIG. 2 (bottom) shows an improvement to a conventional simulation according to FIG. 2 (top). FIG. 2 (bottom) shows a new object model with direction of movement. According to this exemplary embodiment the direction of movement of the neighbor relative to the direction of movement of the object currently being considered is taken into account in addition to the existing people potential model of the repelling effect of a person, as described in the literature. Oncoming objects should offer more resistance than objects with a similar direction of movement. According to FIG. 2 (bottom) the norm of a difference vector comprising the direction of a movement of a object and the direction of movement of a neighboring object is also incorporated as a weighting factor in the object potential calculation. Reference is again made to formulae 1, 2 and 3 hereby. The object potential or people potential is determined in the process. Such a modification means that in the case of neighbors with a similar direction of movement the potential is weighted less strongly than in the case of neighbors with a contrary direction of movement to the current object. These have a repelling effect. Results relating to this are shown in FIG. 2 (bottom). The desired pathway formation that is observed in reality in the case of a counter flow scenario can clearly be seen here and, more precisely, one stream of people from left to right and one from right to left, in the new model. A plurality of people moves one behind the other in pathways in the central region between source and target in particular. With the conventional model according to FIG. 2 (top) no such pathways are generated. By taking account of the direction of movement according to FIG. 2 (bottom) oncoming objects accordingly create more resistance than objects with a similar direction of movement.

FIG. 3 shows an illustrations for linear and exponential potential field functions.

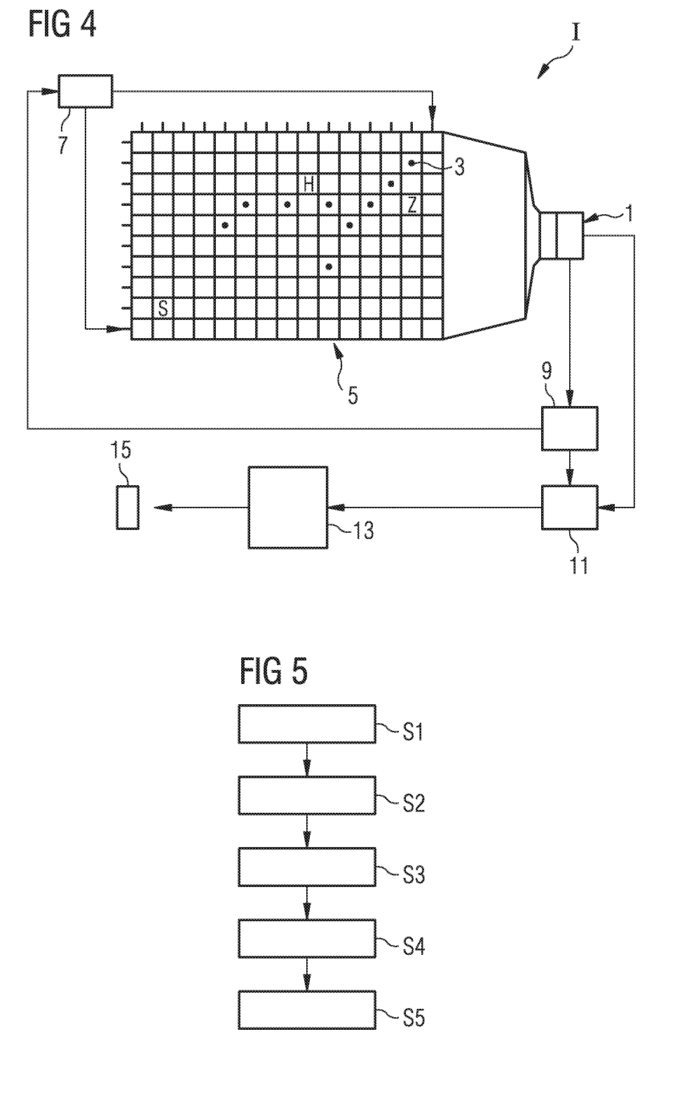

FIG. 4 shows an exemplary embodiment of an apparatus.

The apparatus I generates a movement of objects 3 which, by way of example, can be metal balls. The apparatus I comprises a cellular grid 5 on a spatial area. A total potential that can change over time is allocated to each cell. Objects 3, for example small metal balls, are initially positioned on the cellular grid 5. A number can be n=50 small balls by way of example. Total potential values that change over time can be allocated to the cells by means of a control device 7. An electromagnet by way of example can be allocated to each cell, the magnetic force of which can be adjusted by means of the control device 7. The control device 7 can adjust a respective potential by means of a current through an electromagnet. At a start time Ts the potentials are activated by means of the control device 7. Starting from a respective starting cell S the small balls each move past other small balls and obstacles H to their target Z. All the small balls can have reached their target Z at an end time Te. A first detection device, for example a camera, can be used for visualization and/or detection of the movement of the small balls. The information—this can be the directions of movement of objects 3—from the first detection device 1 can be used in a calculating device 9 to calculate respective object potentials. The information from the first detection device 1 can also be evaluated in an evaluation device 11. Thus, for example, a object density in the cellular grid 5 is detected and evaluated. The evaluation device 11 can emit control signals to a control center 13 for controlling building elements 15, for example doors or signs. The apparatus I can, by way of example, also be simulated by a computer. The apparatus I is suitable in particular for a simulation of streams of people in buildings by way of example. With an appropriate model the model of the apparatus I can be transferred to a computer according to various embodiments. In other words, the apparatus I can also be simulated by a computer. An embodiment of this kind is also incorporated by the scope of this application.

FIG. 5 shows an exemplary embodiment of a method.

In a step S1 an apparatus comprising a spatial area overlaid with a cellular grid 5 is provided, wherein each cell adopts different occupation and total potential states which are adjusted by means of a control device 7 and a calculating device 9, wherein a target potential is allocated to each cell which determines how objects 3 are attracted by a target Z, and an obstruction potential is allocated which determines how objects 3 are repelled by an obstacle H, and wherein a object potential is allocated to the object 3, wherein a total potential in a cell is composed of the values of the target potential and the obstruction potential in the cell and the object potentials of objects 3, detected by means of a first detection device 1, in neighboring cells of the cell. In a step S2 objects 3 are positioned on respective starting cells S, wherein thereafter the objects each switch from one cell to a neighboring cell with the lowest total potential.

In a step S3 the position of the objects 3 is detected by means of the first detection device 1. In a step S4 the total potential states are updated by means of the first detection device 1, the calculating device 9 and the control device 7. In a step S5 a norm of a difference vector comprising direction of movement of a object 3, detected by means of the first detection device, and a direction of movement of a neighboring object 3 is also incorporated as a weighting factor in a calculation of the respective object potential performed by means of the calculating device 9. The method can, by way of example, be generated by means of software.

### BIBLIOGRAPHY

[1] C. Kinkeldey, Fuβgängersimulation auf der Basis zellulärer Automaten [Pedestrian simulation based on cellular machines], chapter 4, student research project, University of Hanover, 2003.

What is claimed is:

1. A method for the simulation of object streams moving in an area based on cellular state machines, wherein the area is overlaid with a cellular grid and each cell can adopt different states which are updated by way of rule sets over time, the method comprising:
basing the rule sets on sub-models which determine how objects are attracted by a target, how objects mutually repel each other and how objects are repelled by an obstruction, and
basing the rule sets on a mathematical formulation of a total potential field over the cellular grid, wherein the total potential in a cell is the sum of values of target potential, object potential and obstruction potential in the cell and objects switch from one cell to a neighboring cell with the lowest total potential, wherein a norm of a difference vector comprising direction of movement of an object and a direction of movement of a neighboring object is also incorporated as a weighting factor in the calculation of the respective object potential.

2. The method according to claim 1, wherein the respective object potential is calculated according to the following formula:
Pot(O)=c(α)*Pot_{conv}(O)
where c(α) is the norm of the difference vector and Pot_{conv}(O) is a conventionally calculated respective object potential.

3. The method according to claim 1, wherein the norm of the difference vector is calculated according to the following formula:
c(α)=∥\vec{v}_{currentpers(α)}−\vec{v}_{neighbor(α)}∥*a+b, with a and b weighting factors
where \vec{v}(α) is the normalized direction vector of an object.

4. The method according to claim 1, wherein the normalized direction vector of an object is calculated according to the following formula:
$$\vec{v} ( α ) = ( \begin{matrix}sin α \\ cos α\end{matrix} )$$
where α indicates the angle of the direction of movement with respect to the target of the object.

5. The method according to claim 2, wherein the conventional object potential Pot_{conv}(O) is determined by a function of the Euclidean distances of the objects from each other.

6. The method according to claim 1, wherein target potential and obstruction potential are each determined by a function of the Euclidean distances of an object from the target and of an object from an obstruction.

7. The method according to claim 5, wherein the function of the Euclidean distances is a linear, quadratic or an exponential function.

8. The method according to claim 6, wherein the function of the Euclidean distances is a linear, quadratic or an exponential function.

9. A system for the simulation of object streams moving in an area based on cellular state machines, wherein the area is overlaid with a cellular grid and each cell can adopt different states which are updated by way of rule sets over time, the system being configured:
to base the rule sets on sub-models which determine how objects are attracted by a target, how objects mutually repel each other and how objects are repelled by an obstruction, and
to base the rule sets on a mathematical formulation of a total potential field over the cellular grid, wherein the total potential in a cell is the sum of values of target potential, object potential and obstruction potential in the cell and objects switch from one cell to a neighboring cell with the lowest total potential, wherein a norm of a difference vector comprising direction of movement of an object and a direction of movement of a neighboring object is also incorporated as a weighting factor in the calculation of the respective object potential.

10. The system according to claim 9, wherein the system is operable to calculate a respective object potential according to the following formula:
Pot(O)=c(α)*Pot_{conv}(O)
where c(α) is the norm of the difference vector and Pot_{conv}(O) is a conventionally calculated respective object potential.

11. The system according to claim 9, wherein the system is operable to calculate the norm of the difference vector according to the following formula:
c(α)=∥\vec{v}_{currentpers(α)}−\vec{v}_{neighbor(α)}∥*a+b, with a and b weighting factors
where v(α) is the normalized direction vector of an object.

12. The system according to claim 9, wherein the system is operable to calculate the normalized direction vector of an object according to the following formula:
$$\vec{v} ( α ) = ( \begin{matrix}sin α \\ cos α\end{matrix} )$$
where α indicates the angle of the direction of movement with respect to the target of the object.

13. The system according to claim 10, wherein the system is operable to determine the conventional object potential Pot_{conv}(O) by a function of the Euclidean distances of the objects from each other.

14. The system according to claim 9, wherein the system is operable to determine a target potential and obstruction potential each by a function of the Euclidean distances of an object from the target and of an object from an obstruction.

15. The system according to claim 13, wherein the function of the Euclidean distances is a linear, quadratic or an exponential function.

16. The system according to claim 14, wherein the function of the Euclidean distances is a linear, quadratic or an exponential function.
